(19) United States
(12) Patent Application Publication
(10) Pub. No.: US 2026/0028004 A1
(43) Pub. Date: Jan. 29, 2026

(54) METHOD FOR DETERMINING A BRAKE PRESSURE AND PRESSURE-MEDIUM-ACTUATED BRAKE DEVICE

(71) Applicant: KNORR-BREMSE Systeme für Nutzfahrzeuge GmbH, München (DE)

(72) Inventor: Oliver JUNDT, Hessigheim (DE)

(21) Appl. No.: 18/993,906

(22) PCT Filed: Jun. 30, 2023
(86) PCT No.: PCT/EP2023/068060

§ 371 Date: Jan. 13, 2025

(30) Foreign Application Priority Data
Jul. 14, 2022 (DE) 10 2022 117 667.3

(51) Int. Cl. B60T 8/88; B60T 8/171; B60T 8/172; B60T 8/18; F16D 66/00

(52) U.S. Cl. CPC B60T 8/885; B60T 8/171; B60T 8/172; B60T 8/1881; F16D 66/00; B60T 2210/124; B60T 2240/00; B60T 2270/10; B60T 2270/20; B60T 2270/416; B60T 2270/88; F16D 2066/005; F16D 2066/006

(57) ABSTRACT

Methods for determining or estimating a first brake pressure for a first brake actuator. Methods are directed towards, for example, situations where a pressure-medium-actuated brake device of at least one first wheel, at which a brake-pressure buildup is necessary during a braking operation, at which for example, there is no first wheel-speed sensor. Methods are also directed towards situations, for example, where a first wheel-speed sensor does not produce a first wheel-speed signal. Methods include determining, measuring, or estimating, during the braking operation and/or during the execution of the controlling operation, a second brake pressure for a second brake actuator.

The invention relates to a method for controlling a brake device of a vehicle according to claim 1 and a brake device of a vehicle according to claim 15.

Modern brake systems comprise travel dynamic control systems which, for example, comprise functions such as a traction control system (TCS), an anti-lock braking system (ABS) and/or an electronic stability program (ESP). The invention relates to an ESP-controller for motor vehicles, with hierarchically organized basic functions which comprise at least one vehicle dynamic controller (VDC) and an anti-lock braking system (ABS or ABSplus) and which may have additional basic functions or systems, such as TCS, MSR, EBD, ICC, BA, etc., wherein the vehicle dynamic control (VDC control) is superior to other basic functions or systems and calculates an additional yaw moment (Δ M).

There are requirements to also configure the vehicle dynamic control system in a redundant manner. In other words, even in the event of a function loss of the vehicle dynamic control system an at least rudimentary vehicle dynamic control should still be possible in order to be able to at least partially maintain the vehicle stability or the deceleration capacity. In particular vehicles having (partially) automated travel functions which take the driving function and responsibility from the driver at least for a limited time and which can thus, for example, be operated autonomously, must be able to continue the driving of the vehicle in the event of any error until the driver takes over the vehicle driving again. The system property “Fail Operational” derived from this requires the basic functions of the vehicle to be ensured, in particular on the execution level, at least with functional limitations. For the brake control in autonomous travel operation, this means that, when any error occurs, the operating brake device can continue to be operated in an electronically controlled manner so that vehicle dynamic control functions, such as, for example ABS, TCS und ESP can continue to be implemented, even though potentially with limitations.

The vehicle dynamic control system and in this instance in particular the ABS, has great significance in this context. High demands are thus placed on the ABS with regard to its availability. This is because, with a conventional vehicle, the ABS can be simply switched off in the event of an error and the driver can be made aware of this switching off in order to keep him/her in a more cautious travel mode. In the case of autonomous or partially autonomous driving, however, the vehicle system remains in complete control for a long period of time or even permanently. A frequent error which in a conventional vehicle leads to the ABS being switched off is the failure of a wheel signal which is used by the ABS for slip recognition and slip control on the corresponding vehicle wheel. In order to prevent this error, the corresponding wheel sensor system (where applicable including the supply lines) can be configured to be redundant. Such a redundancy is, however, linked with high costs. Alternatively, with a wheel signal failure, for example for a front wheel, a control on the wheels of the front axle could be switched off and a concentration could be carried out on the wheels of the rear axle in order to at least prevent overcontrol. The stability limitations resulting from this approach are, however, in many cases, as with autonomous or partially autonomous driving, not acceptable.

A redundancy of all the components of the electro-pneumatic operating brake device in order to form a complete redundancy is expedient with regard to maintaining the functionality even in the event of an error, but is not acceptable with regard to costs, structural space and weight, in particular in series production.

An object of the present disclosure is to set out technical solutions which are less susceptible to the failure of a wheel signal.

This object is achieved according to the invention by the features of claims 1 and 15.

### STATEMENT OF INVENTION

According to a first aspect of the invention, a method is proposed for determining or estimating a first brake pressure for a first brake actuator, which is included by a pressure-medium-actuated brake device, of at least a first wheel on which during a braking operation and/or while implementing a control which processes wheel speed signals a build-up of brake pressure is required, and on which no first wheel speed sensor is provided, or a first wheel speed sensor is provided but does not provide any or any error-free first wheel speed signal, wherein the method comprises at least the following steps:
a) determining, measuring or estimating during the braking operation and/or while the control is carried out a second brake pressure for a second brake actuator, which is included by the brake device, of at least one second wheel with which there is associated a second wheel speed sensor which provides, for example, an error-free wheel speed signal, and
b) determining or estimating the first brake pressure in accordance with the second brake pressure.

The method may further in particular also comprise the step of controlling the first brake pressure in the first brake actuator during the braking operation and/or when the control is carried out. In particular, therefore, the first brake pressure which is determined or estimated with the method is used to activate the first brake actuator during the braking operation and/or when the control is carried out. The method may in particular also comprise the step of identifying a failure of the first wheel speed signal or an error in the first wheel speed signal, and/or a first position of the first wheel which is associated with the first wheel speed sensor on the vehicle. The brake device which is described below can also be configured accordingly.

Identification of a failure or error of the first wheel speed signal of the first wheel speed sensor may, for example, be carried out by means of a plausibility check in particular by means of a comparison with the wheel speed signal provided by another wheel speed sensor. The failure or the error of the first wheel speed signal therefore includes a non-plausible first wheel speed signal. The determination, measurement or estimation of the second brake pressure for the second brake actuator is carried out in particular on a second wheel which is not affected by a failure or error of the first wheel speed signal.

The method may in particular also comprise the step of checking whether the second wheel speed signal is error-free or not, wherein in the error-free case it is used to determine, estimate or calculate the second brake pressure and otherwise it is not.

The invention further takes into account cases in which no wheel speed sensor at all is arranged on at least a first wheel and a first wheel speed sensor is then missing at that location. This is because, in such cases, a first wheel speed signal can also be provided. The lack of a first wheel speed sensor may in particular be present on all wheels of an axle which is generally not sensed with respect to the wheel speeds of the wheels.

In other words, the result, that is to say, a first wheel speed signal which cannot be validated to carry out the control and/or for the braking operation for the at least one first wheel, is adjusted in both cases, that is to say, when there is generally no first wheel speed sensor provided on the at least one first wheel and also in the event that, on the at least one first wheel, a wheel speed sensor is provided, but provides no or a false wheel speed signal.

In both cases, the invention provides a replacement strategy in order to nonetheless allow on wheels which are not speed-sensed or which cannot be speed-sensed an (individual wheel) control which requires wheel speed signals as input signals, such as, for example, an ABS control.

One embodiment of the invention has recognized that knowledge of the position of the first wheel on the vehicle may be advantageous in order to identify at least one suitable second wheel on the vehicle (or the position thereof on the vehicle), the second brake pressure of which can then be used as a basis for determining or estimating the first brake pressure.

In the simplest case, the second brake pressure for the second brake actuator of the at least one second brake actuator or the time path of this second brake pressure is substantially identically “copied” in order to act as a replacement for the first brake pressure in the first brake actuator of the at least one first wheel. Otherwise, this second brake pressure can also be changed in order to be used as a replacement for the first brake pressure. With the invention, therefore, a failure of at least one wheel speed signal is compensated for in order to be able to carry out the control without notable losses of control quality.

However, the method and a brake device which is described below according to the invention prevent the second wheel speed signal of the second wheel speed sensor which is functional or has not been affected by a failure from being used as a replacement signal for the failed first wheel speed signal and the first brake pressure then being determined or estimated based on the second wheel speed signal. The reason is that a transmission of the second wheel speed of the second wheel to the first wheel on the same axle or another axle does not lead to satisfactory control quality.

The control may in particular comprise a travel dynamic control (TDC) with a subordinate anti-lock brake control function and/or traction control function and/or roll-over protection function and/or an anti-lock braking system (ABS) and/or a traction control system (TCS).

With the method, a selection can also be made from the wheels of the vehicle in order to identify at least one second wheel which is suitable for the determination or estimation of the first brake pressure for the first brake actuator of the at least one first wheel.

According to a further development, in the method it is possible to use as the second wheel a wheel which is arranged on the same axle as the first wheel.

Alternatively, it is possible to use as the second wheel a wheel which is arranged on a different axle with respect to an axle on which the at least one first wheel is arranged. In this instance, it is possible to use as the second wheel a wheel which is arranged with respect to the vehicle side of the at least one first wheel at the same vehicle side or at the other vehicle side.

Also in the method a μ-split identification in order to identify a μ-split situation can be carried out during the braking operation.

In a particularly preferred manner, in the method the determination or estimation of the first brake pressure for the at least one first wheel is also carried out in accordance with an identified μ-split situation during the braking operation.

In the method, for example, there is used as the second wheel a wheel which is arranged on the same axle as the at least one first wheel, and the determination or estimation of the first brake pressure for the first brake actuator of the at least one first wheel is also carried out in accordance with an identified μ-split situation.

In a particularly preferred manner, in the method a determination or estimation of axle loads of the axles and/or an axle load distribution of the axles is also carried out. The determination or estimation of the first brake pressure for the at least one first wheel can then also be carried out in accordance with the determined or estimated axle loads or the determined or estimated axle load distribution.

In particular in the method there is used as the second wheel a wheel which is arranged on a different axle with respect to an axle on which the at least one first wheel is arranged, but at the same vehicle side as the at least one first wheel, wherein the determination or estimation of the first brake pressure for the first brake actuator of the at least one first wheel is also carried out in accordance with the determined or estimated axle loads or the determined or estimated axle load distribution.

The invention also comprises according to another aspect a computer program having a program code for carrying out the method described above, particularly when the computer program is carried out on a processor device.

In another aspect of the invention, a control device or a control device system having a processor device and a store which contains the computer program is also proposed. The control device or the control device system may in particular be a component of a brake device of a vehicle as described below.

In another aspect of the invention, a pressure-medium-actuated brake device, which is provided with at least one control which receives and processes wheel speed signals from wheel speed sensors as input signals, of a vehicle is proposed, wherein a brake actuator of the brake device is associated in each case with wheels of the vehicle and there is associated with at least some wheels of the vehicle a wheel speed sensor of the brake device which produces wheel speed signals which correspond to the wheel speed, and wherein the brake device is configured
a) to determine or estimate a first brake pressure for a first brake actuator, which is included by the brake device, of at least a first wheel on which during a braking operation and/or while a control which processes wheel speed signals is carried out a brake pressure build-up is necessary and on which no first wheel speed sensor is provided, or a first wheel speed sensor is provided but does not provide any or any error-free first wheel speed signal, and
b) to determine, measure or estimate a second brake pressure for a second brake actuator, which is included by the brake device, of at least one second wheel during the braking operation and/or while the control is carried out and with which there is associated a second wheel speed sensor which provides, for example, an error-free wheel speed signal, and
c) to determine or estimate the first brake pressure in accordance with the second brake pressure.

Furthermore, the pressure-medium-actuated braked device may preferably be configured to produce the first brake pressure and to introduce it into the first brake actuator of the at least one first wheel.

The control may in particular be a vehicle dynamic control (ESP) with a subordinate anti-lock brake control function and/or traction control function and/or roll-over protection function and/or an anti-lock braking system (ABS) and/or a traction control system (TCS).

Furthermore, the brake device may be configured to make a selection from the wheels of the vehicle in order to identify at least one second wheel which is suitable for the determination or estimation of the first brake pressure for the first brake actuator of the at least one first wheel.

The second wheel may also be a wheel which is arranged on the same axle as the first wheel.

Alternatively, the second wheel may be a wheel which is arranged on a different axle with respect to an axle on which the at least one first wheel is arranged. In this instance, the second wheel may in particular be a wheel which, with respect to the vehicle side of the at least one first wheel, is arranged at the same vehicle side or at the other vehicle side.

According to a further development, the brake device may be configured so that a μ-split -identification is carried out in order to identify a μ-split situation during the braking operation. In particular, the brake device may be configured so that the determination or estimation of the first brake pressure is also carried out in accordance with an identified μ-split situation during the braking operation.

In this instance, the second wheel may be a wheel which is arranged on the same axle as the at least one first wheel, and the brake device may be configured so that the determination or estimation of the first brake pressure is also carried out in accordance with an identified μ-split situation.

In a particularly preferred manner, the brake device is configured so that a determination or estimation of axle loads of the axles and/or an axle load distribution of the axles is carried out.

In this instance, the brake device may be configured so that the determination or estimation of the first brake pressure for the at least one first wheel is also carried out in accordance with the determined or estimated axle loads or the determined or estimated axle load distribution.

In particular, the second wheel may be a wheel which is arranged on a different axle with respect to an axle on which the at least one first wheel is arranged, but is arranged at the same vehicle side as the at least one first wheel, and the brake device may be configured so that the determination or estimation of the first brake pressure is also carried out in accordance with the determined or estimated axle loads or the determined or estimated axle load distribution.

In the brake device, the control can be implemented in at least one electronic control device or an electronic control device system. In this instance, for example, a primary electronic control device and a secondary electronic control device may be provided, wherein the control is implemented in the primary control device and/or in the secondary control device. In a further development, at least some of the wheel speed sensors, preferably all the wheel speed sensors may be connected to the primary control device and/or to the secondary control device in order to transmit wheel speed signals.

In a particularly preferred manner, the brake device is an electro-pneumatic brake device having brake pressure regulation. Such a brake device is also referred to as an electronically controlled brake system (EBS). Pneumatic operating brake cylinders are preferably used as brake actuators. However, the invention is not limited to electro-pneumatic brake devices. It can also be carried out in any type of pressure-medium-actuated and electrical brake devices such as electro-hydraulic brake devices.

For example, therefore, a μ-split identification can be carried out on an axle of the vehicle in which the wheel speed sensors at both sides of the axle provide wheel speed signals.

The information relating to an identified μ-split situation is now-in addition to the second brake pressure for the second brake actuator of the at least one second wheel, which is arranged on the same axle as the at least one first wheel-taken into account or used for the determination, calculation or estimation of the first brake pressure for the first brake actuator of the at least one first wheel, the first wheel speed sensor of which provides no wheel speed signals.

One embodiment of the method or the brake device takes into account in particular a braking operation in which brake interventions are carried out on all the wheels of the vehicle in order to brake the vehicle. In the braking operation, a control which does not involve any stability intervention but instead, for example, an anti-lock braking intervention (ABS) and/or a roll-over protection intervention may be active.

In this instance, the determination, calculation or estimation of the first brake pressure for the first brake actuator of the at least one first wheel, the first wheel speed sensor of which provides no wheel speed signals, can be carried out in accordance with the second brake pressure for the second brake actuator of the at least one second wheel with a wheel speed sensor (which functions or provides wheel speed signals) of the same vehicle side, but on another axle, whereby, for example, a μ-split situation is taken into account. In addition, the determination, calculation or estimation of the first brake pressure for the first brake actuator of the at least one first wheel can be established, calculated or estimated in accordance with the axle load ratio between the axle with the at least one first wheel and another axle having the at least one second wheel. In this instance, the axle loads of one axle and the other axle can be measured or estimated.

With identified travel on a bend, a contact force displacement in the direction toward the outer side of the bend can also be taken into account and the brake pressure at the bend outer side can be increased in relative terms or reduced at the bend inner side, depending on whether the erroneous wheel speed sensor is located at the bend inner side or bend outer side.

The method and the brake device also include an embodiment in which for the first wheels on an axle optionally two pressure control channels for individual wheel control of the wheel brake pressure may be provided, but wheel speed sensors are not arranged or provided on any of these first wheels of this one axle. Since no wheel speed signals are provided on this one axle for all the first wheels, the axle load ratio with respect to at least one other axle and/or the axle loads of the two axles is/are preferably measured or estimated. The (common) first brake pressure for the first brake actuators of the first wheels of this one axle can then be determined, estimated or calculated in accordance with the second brake pressure, for example, at the same side, for the second brake actuators of the second wheels on the other axle and in accordance with the axle load ratio or the axle loads.

The method and the brake device also include, for example, an embodiment in which only one stability intervention by a vehicle dynamic control (ESP) is carried out in order, for example, to react to the impending over-control or under-control of the vehicle without, for example, brake interventions being carried out on all the wheels of the vehicle for braking the vehicle in this instance.

In this instance, the vehicle dynamic control (ESP) calculates from a rotation rate control deviation a desired value for the brake pressures of specific wheels of the vehicle and a maximum permissible slip for these wheels. If at least one of these wheels is a first wheel on an axle, the first wheel speed sensor of which provides no wheel speed signals, a traction control on this at least one first wheel is not possible. In this instance, for example, no μ-split identification is also possible on another axle, on which the wheels provide valid wheel speed signals since, for example, not all the wheels on this other axle are braked during the ESP intervention and also not necessary since in this instance individual wheel braking actions are the control objective.

If, in this embodiment, for example, to counter an under-control of the vehicle on the rear axle, ESP interventions are carried out, in the brake actuator of the inner wheel of the rear axle on the bend, for example, a higher brake pressure is controlled than in the brake actuator of the outer wheel of the rear axle on the bend. If the wheel speed sensor of the outer wheel on the bend then does not or cannot provide wheel speed signals, on the inner wheel on the bend the brake pressure is adjusted in accordance with the relevant slip specification for the inner wheel on the bend. On the outer wheel on the bend, a brake pressure which is lower in comparison with the brake pressure of the inner wheel on the bend is then adjusted. If the wheel speed sensor of the inner wheel on the bend provides no wheel speed signals, on the outer wheel on the bend the brake pressure is adjusted in accordance, for example, with a reduced slip specification. On the inner wheel on the bend, a higher brake pressure in comparison with the outer wheel on the bend is adjusted.

If, in this embodiment, for example, to counter an over-control of the vehicle on the front axle, EPS interventions are carried out, a high slip and a reduction of the lateral guiding force are the objectives of the control strategy. If on a wheel which is intended to be controlled the relevant wheel speed sensor provides no wheel speed signals, the slip cannot be limited. An excessively high slip can lead to blocking of this wheel, which in this instance is in accordance with the control strategy, but with the tire wear then being increased. In order to reduce the tire wear, the brake pressure on the relevant wheel can be reduced so that the brake blocking of this wheel is consequently also reduced.

The method and the brake device also include, for example, an embodiment in which during a braking operation a brake intervention is carried out on all the wheels of the vehicle in order to brake the vehicle and (at the same time) a stability intervention is carried out by a vehicle dynamic control (ESP).

If, for example, as a result of brake interventions on the rear axle, an impending under-control of the vehicle is then intended to be prevented, and if a first wheel speed sensor of a first wheel on the rear axle cannot provide any wheel speed signals, a μ-split identification is, for example, preferably carried out on the front axle and a μ-split situation is thereby identified under some circumstances. Depending on an identified μ-split situation on the front axle, the first brake pressure for the first brake actuator on the rear axle is then determined or estimated in accordance with the identified μ-split situation.

According to another embodiment, the contact forces of all the wheels can also be estimated or established, for example, by means of an axle load measurement of a pneumatic suspension of the vehicle which then supplies the axle loads, for example, via a CAN data bus to an electronic control device (for example, the) brake control device for further processing. A model which is integrated in the control device can then establish the dynamic axle load displacement during the braking operation and/or during the intervention of the control (for example, via the detected transverse acceleration, the detected roll angle or the detected roll rate of the vehicle) so that the effect of the dynamic axle load displacement during the braking operation and/or during the intervention of the control can also be taken into account during the establishment of the first brake pressure.

Consequently, the first brake pressure for the first brake actuator of the at least one first wheel, on which during the braking operation and/or during the implementation of the control a build-up of brake pressure is required, is preferably also estimated or determined depending on a dynamic axle load displacement which occurs during the braking operation and/or during the implementation of the control.

According to a further development of this embodiment, on the axle using wheel speed sensors which all provide error-free wheel speed signals, during the braking operation the friction coefficient between the wheels of this axle and the carriageway can be estimated. The first brake pressure of the first wheel with the wheel speed signal which is not provided or which is erroneous is then also calculated in accordance with an estimated wheel contact force of this first wheel and the friction coefficient of the wheel which provides an erroneous wheel speed signal at the same vehicle side.

In addition, during the determination of the first brake pressure p1 it can also be taken into account that when travelling on bends the outer wheel on the bend runs more quickly (for example, above the measured rotation rate).

According to another embodiment, the vehicle may have an additional rear axle but on which no wheel speed sensors are installed, but in which for each wheel of this additional rear axle an individual pressure regulation channel is provided in the brake device. For example, this may be a utility vehicle in which the front axle represents an articulated axle and an individual wheel speed sensor and an individual brake pressure regulation channel is provided for each wheel. The first rear axle has, for example, for each wheel, a wheel speed sensor and an individual brake pressure regulation channel and an axle load sensor system which detects the axle load of the first rear axle. Since the brake pressures of the wheels of the second rear axle, for example, with an ABS control cannot be adapted using the wheel speeds since there is no wheel speed information at that location, these brake pressures then represent “first brake pressures” in the context of the previously used nomenclature.

In this instance, the first brake pressure p1R on the right, non-speed-sensed wheel of the second rear axle can, for example, be determined in accordance with the second brake pressure p2R of the right wheel of the first rear axle at the same side and in accordance with the axle load ratio between the first and second rear axle. In a similar manner, the first brake pressure p1L on the left, non-speed-sensed wheel of the second rear axle can be determined, for example, in accordance with the second brake pressure p2L of the left wheel of the first rear axle at the same side and in accordance with the axle load ratio between the first and second rear axle.

Advantageous further developments of the invention will be appreciated from the patent claims, the description and the drawings. The advantages of features and combinations of a plurality of features mentioned in the introduction to the description are purely exemplary and can be alternatively or cumulatively effective without the advantages of embodiments according to the invention necessarily having to be achieved. Other features can be derived from the drawings—in particular the geometries illustrated and the relative dimensions of a plurality of components with respect to each other and their relative arrangement and operational effect. The combination of features of different embodiments of the invention or features of different patent claims is also possible in a manner different from the selected back-dependencies of the patent claims and is thereby suggested. This also relates to those features which are illustrated in separate drawings or as are mentioned in the description thereof. These features can also be combined with features of different patent claims. Features set out in the patent claims can also be dispensed with for other embodiments of the invention.

### DRAWINGS

Exemplary embodiments of the invention are illustrated below in the drawings and explained in greater detail in the following description. In the drawings:

FIG. 1 shows a schematic circuit diagram of a preferred embodiment of an electro-pneumatic operating brake device as a preferred embodiment of the invention, wherein pneumatic connections are shown therein;

FIG. 2 shows a schematic circuit diagram of the operating brake device of FIG. 1, wherein electrical connections and partially pneumatic connections are shown therein;

FIG. 3 shows a schematic cross sectional illustration of an operating brake valve device of the electro-pneumatic operating brake device of FIG. 1 and FIG. 2 according to a preferred embodiment of the invention in a “drive” position;

FIG. 4 shows a schematic illustration of functional units, which carry out an ABS control which is implemented in the electro-pneumatic operating brake device of FIG. 1 and FIG. 2;

FIG. 5 shows a schematic illustration of a time brake pressure path of a braking operation which is carried out using the electro-pneumatic operating brake device of FIG. 1 and FIG. 2;

FIG. 6 shows a flow chart of a method for controlling the electro-pneumatic operating brake device according to a preferred embodiment.

### DESCRIPTION OF THE EXEMPLARY EMBODIMENTS

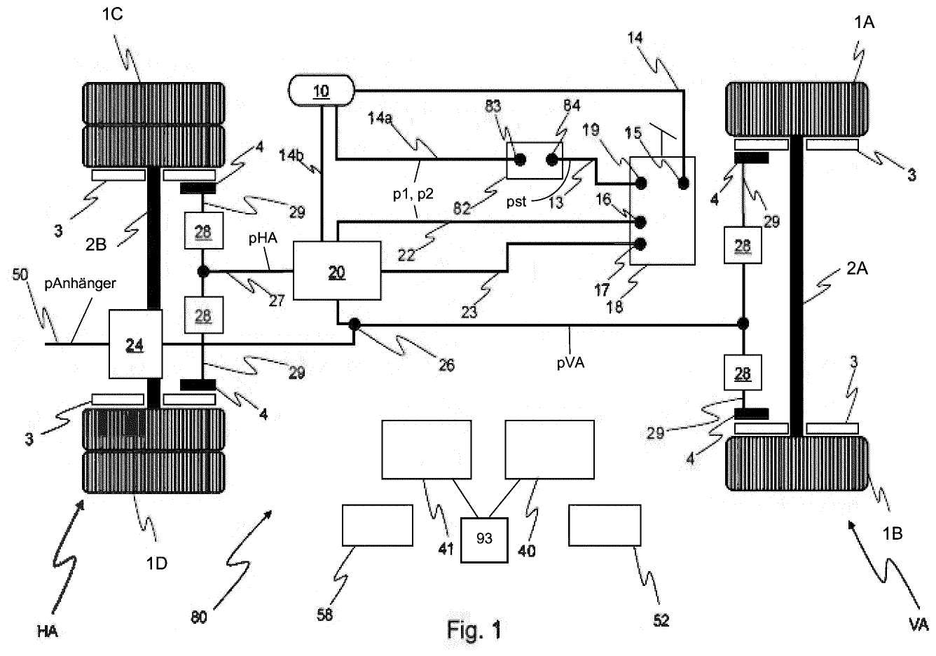

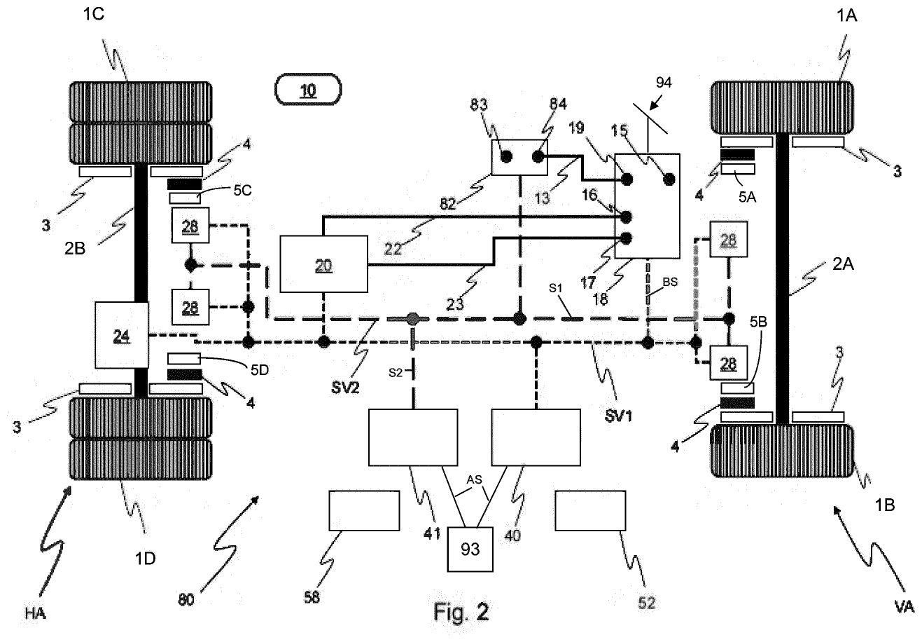

FIG. 1 shows a schematic circuit diagram of an electro-pneumatic operating brake device 80 as a preferred embodiment of a brake device according to the invention, wherein pneumatic connections are shown therein, and FIG. 2 shows a schematic circuit diagram of the electro-pneumatic operating brake device 80 of FIG. 1, wherein electrical connections and partially pneumatic connections are shown therein. The following description of the electro-pneumatic operating brake device 80 relates to both Figures.

A first axle 2A, for example, a front axle VA, and a second axle 2B, for example, a rear axle HA, are shown. The first axle 2A has, arranged in each case at different vehicle sides, a first wheel 1A and a second wheel 2B and the second axle 2B has a third wheel 1C and a fourth wheel 2D. There is associated in each case with the wheels 1A, 1B, 1C and 1D a pneumatic wheel brake actuator 4 which in the example shown is in the form of a pneumatic operating brake cylinder. Such a pneumatic wheel brake actuator 4 is arranged on each wheel 1 and actuates in this instance, for example, a disk brake 3 in order to produce a brake force.

In order to carry out an operating braking operation, the pneumatic wheel brake actuators 4 are acted on with a brake pressure p_{VA} or p_{HA}, whereby a friction force is produced in the disk brakes 3 and results in a braking torque. Furthermore, on the wheels 1A-1D wheel speed sensors shown in FIG. 2 are provided, that is to say, on the first wheel 1A a first wheel speed sensor 5A, on the second wheel 1B a second wheel speed sensor 5B, on the third wheel 1C a third wheel speed sensor 5C and on the fourth wheel 1D a fourth wheel speed sensor 5D in order to detect the wheel speeds of the four wheels 1A-1D and to process them in higher functions such as ABS, TCS and/or ESP.

The illustration of additional components of the vehicle and in particular the axle structure or the structure of the brakes has been omitted in this illustration for reasons of clarity. Furthermore, such a brake and vehicle structure is not intended to be considered to be limiting for the subject-matter of the invention. It serves only as an example to explain the operating method of the subject-matter according to the invention. Instead, alternative structural possibilities of an electro-pneumatic operating brake device are also conceivable, such as, for example, drum brakes in place of the disk brakes 3 shown. Other embodiments of a vehicle are also conceivable. Thus, for example, more than one front or rear axle VA, HA that is to say, in total more than two axles, could be provided.

The electro-pneumatic operating brake device 80 will now be described below. This has a compressed air store 10 which via supply lines 14, 14a, 14b, 14c supplies different components 18, 20, 24, 82 of the electro-pneumatic operating brake device 80 with compressed air.

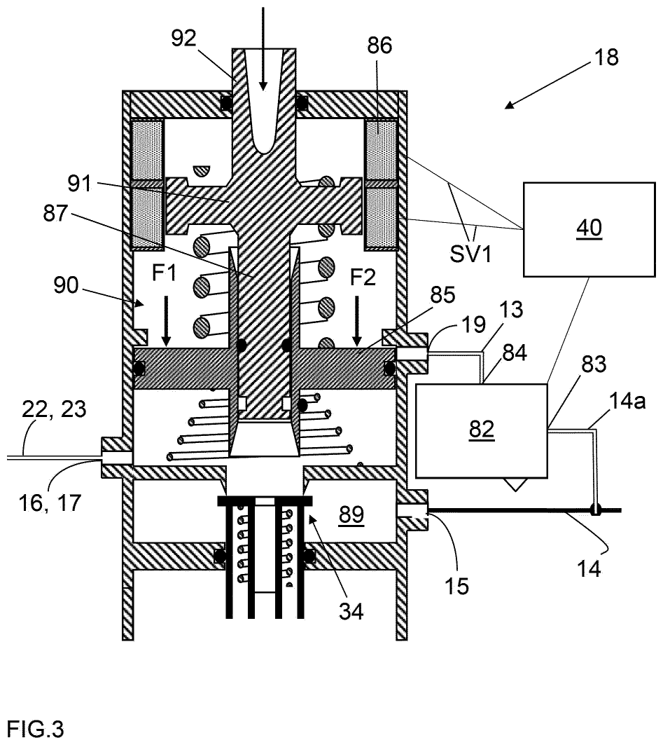

A component is in this instance an electro-pneumatic operating brake valve device 18 which is schematically shown in FIG. 3, in this instance, for example, in the form of a foot brake module which is connected to the supply line 14 via a supply input 15. Via this, the operating brake valve device 18 is supplied with compressed air. The operating brake valve device 18 further has a pneumatic control input 19 via which it can receive a pneumatic control pressure p_{St} with which the operating brake valve device 18 is then pneumatically controlled. Furthermore, the operating brake valve device 18 has two pneumatic control outputs 16, 17 via which it can control a first pneumatic brake control pressure p₁ and/or a second pneumatic brake control pressure p₂ in pneumatic control lines 22, 23.

Furthermore, the operating brake valve device 18 has an operating brake actuation member 94, such as, for example, a brake pedal via which braking requests of a driver can be input. The operating brake valve device 18 is configured to detect a braking request of the driver via an in particular electrical brake value transmitter 86 which is shown in FIG. 3 and which operates in a contactless manner within the electrical channel thereof and to introduce it as an electrical activation signal BS which is dependent on an activation into a primary control connection SV1, as shown in FIG. 2. Via the primary control connection SV1, the electrical activation signal BS is then introduced into a primary electronic brake control device 40 which in this instance is formed, for example, by the electronic EBS control device. Depending on the activation signal BS, the primary electronic brake control device 40 then produces a first electric braking request signal S1 in which higher functions, such as, for example, an axle-load-dependent brake force distribution are also taken into account. In this regard, the first electrical braking request signal S1 for the front axle VA and rear axle HA can also be differentiated or is formed in an axle-related manner.

The operating brake valve device 18 has a housing in which a tappet piston 91 having a tappet receiving member 92 which protrudes through a cover opening of a housing cover is axially movably received. In the tappet piston receiving member 92 there protrudes from above a tappet which is not shown here and which is connected to the operating brake actuation member 94, in this instance, for example, in the form of a foot brake plate. If the driver therefore activates the operating brake actuation member 94, the tappet presses into the tappet receiving member 92 and the tappet piston 91 is moved downward by the actuation force in FIG. 3, as indicated at that location by the arrow. The tappet piston 91 transmits the actuation force to a control piston 85 which is also axially movably supported in the housing 2, preferably via a tappet piston pressure spring 102.

Furthermore, the control piston 85 is mechanically operationally connected to the tappet piston 91 by means of a tappet piston rod 87, wherein the tappet piston rod 87 is connected to the tappet piston 91 and can axially strike in an end of the control piston 85 in the form of a cup-like sleeve 103 when the tappet piston rod 87 has reached the base of the sleeve 103, when, for example, the tappet piston 91 is moved toward the control piston 85 as a result of an activation of the operating brake actuation member 94. On the other hand, the tappet piston rod 87 can slide in the sleeve 103 when the tappet piston 91 is moved away from the control piston 85.

At the other side of the control piston 85 there is formed on a piston rod of the control piston 85 an outlet seat of a dual-seat valve 88 which seals with respect to a cup-like and hollow valve member, which is axially movably supported in the housing, of the dual-seat valve 88 or, in a state raised off this, releases a flow cross section between a working chamber 98 and a head-side through-opening in the valve member, which leads to a ventilation connection 99. The working chamber 98 is connected to the control outlets 16, 17 and they are connected to the control lines 22, 23 which in turn are connected to the pneumatic control inputs 95, 96 of a pressure regulation module 20. For clarity, in this instance the control outputs 16, 17 are placed in the drawings at one connection; in reality, however, two separate control outputs 16, 17 are provided.

In the operating brake valve device 18, a control chamber 90 is formed between the tappet piston 91 and the face of the control piston 85 facing it. In this instance, the pneumatic control input 19 on the housing opens in the control chamber 90.

The control line 13 and consequently also the control output 84 of a solenoid valve device 82, which is connected at the supply input 83 thereof to the supply line 14a which is connected to a compressed air store 10, is connected to the pneumatic control input 19.

Furthermore, the supply input 15 to which the supply line 14 is connected and which is connected to a storage chamber 89 of the operating brake valve device 18 is also provided on the housing of the operating brake valve device 18.

The valve member is urged by means of a valve member pressure spring which is supported on the base of the housing and on the inner side of the valve member against an inlet seat of the dual-seat valve 88 which is formed at a radially inner edge of a central through-hole of another inner wall of the housing. In the state of the valve member raised from the inlet seat counter to the action of the valve member pressure spring, a flow cross section between the supply input 15 or the storage chamber 89 and the working chamber 98 is released and enables a flow of compressed air which is under store pressure into the control outlets 16, 17, that is to say, into the control lines 22, 23, in order to ventilate the wheel brake actuators 4 of the relevant axle or the relevant brake circuit, front axle brake circuit and rear axle brake circuit.

FIG. 3 shows the position “drive” of the operating brake valve device 18, in which the outlet seat is raised from the valve member and the control outputs 16, 17 and consequently also the wheel brake actuators 4 which are connected at that location are connected to the ventilation connection 99. The active pneumatic wheel brake actuators 4 are thereby released.

A pressure regulation module 20 according to FIG. 1 and FIG. 2 is adequately known, for example, from page 763, in particular image E of “Kraftfahrtechnisches Taschenbuch”, (“Automotive Pocketbook”), 24th Edition, April 2002, Robert Bosch GmbH. The pressure regulation module 20 which is, for example, dual-channel here, contains per channel (in this instance, for example, front axle channel and rear axle channel) one electromagnetic back-up valve which is controlled in this instance by the primary electronic brake control device 40, wherein a back-up valve is connected in each case to a pneumatic control input 95, 96. At the output, the back-up valve is connected to a pneumatic control input of an integrated relay valve. Such a back-up valve switches into the state thereof supplied with energy by the primary electronic brake control device 40, that is to say, with an intact operating brake circuit, into the locking position thereof and thereby holds back a pneumatic brake control pressure applied thereto. In the state supplied with energy, the back-up valve switches into the passage position thereof, whereby the pneumatic brake control pressure can act on the relay valve which subsequently increases the quantity of pneumatic brake control pressure on the basis of the store pressure introduced into the pressure regulating module 20 from the compressed air store 10 and then controls as front axle brake pressure p_{VA} and rear axle brake pressure p_{HA} at pressure outputs of the pressure regulation module 20 in lines 26, 27, which are connected to the wheel brake actuators 4 by means of pressure control valves 28. The pressure control valves 28 are preferably connected to the primary control connection SV1 and to a secondary control connection SV2.

In addition, the pressure regulation module 20 has an inlet/outlet solenoid valve combination which is controlled by an integrated electronic pressure regulation module control device and which is connected at the output side to the pneumatic control input of the relay valve. Therefore, the relay valve can be acted on either by the pneumatic brake control pressure which is controlled through the non-energized back-up valve or by the pneumatic brake control pressure which is produced in an electrical manner by the control of the inlet/outlet solenoid valve combination by means of the integrated electronic pressure regulation module control device. The pressure regulation module control device is connected via an electric control input 97 to the primary control connection SV1 to which the primary electronic brake control device 40 is also connected, whereby the pressure regulation module control device can be controlled or can be supplied with control signals by the primary electronic brake control device 40.

In addition, a pressure sensor for measuring the actual brake pressure p_{VA} or p_{HA} controlled by the relay valve is integrated in such a pressure regulation module 20. The actual brake pressure measured by the pressure sensor is then balanced out with a desired brake pressure in the context of a pressure control which is represented by a first electric braking request signal S1 which is introduced by the first brake control device 40 into the primary control connection SV1. To this end, the electronic pressure regulation module control device of the pressure regulation module 20 comprises corresponding pressure regulation routines.

The solenoid valve device 82 enables an electronically controlled aeration or ventilation of the control chamber 90 and is electrically controlled by a secondary electronic brake control device 41. To this end, the solenoid valve device 82 is connected with an electric control input to a secondary control connection SV2 which in this instance is formed, for example, by a second CAN data bus.

In particular, the primary electronic brake control device 40, the electrical/electronic portion of the pressure regulation module 20 and the brake value transmitter 86 of the operating brake valve device 18 are connected to the primary control connection SV1, which is separate and independent of the secondary control connection SV2 to which the secondary electronic brake control device 41 and the solenoid valve 82 are connected.

In particular, a data connection 101 may be provided between the primary electronic brake control device 40 and the secondary electronic brake control device 41, in particular for a data and signal exchange and/or for the purposes of mutual monitoring. In particular, via the data connection 101, the activation signal BS and/or the first electrical braking request signal S1 can also be introduced into the secondary electronic brake control device 41 and/or the second electrical braking request signal S2 can also be introduced into the primary electronic brake control device 40. An intact nature of the primary electronic brake control device 40 and the secondary electronic brake control device 41 are not required for this purpose since the signals are preferably only looped through.

The solenoid valve device 82 preferably has in addition to a ventilation 100 shown in FIG. 3 at least one pressure sensor which is not shown here for measuring the actual value of the pneumatic control pressure p_{ST} at the control output 84 so that, in connection with corresponding algorithms in the secondary electronic brake control device 41 to which this actual value is transmitted, a pressure regulation of the controlled control pressure p_{ST} is possible or also preferably carried out.

The secondary electronic brake control device 41 controls the solenoid valve device 82 via the secondary control connection SV2 by means of a second electrical braking request signal S2, wherein the solenoid valve device 82 then produces the pneumatic control pressure p_{ST} at the control output 84 in accordance with the second electrical braking request signal S2.

For example, within the solenoid valve device 82 an electro-pneumatic proportional valve can ensure a control pressure p_{St} which is (proportionally) controlled in accordance with the second electrical braking request signal S2 at the control output 84, wherein an aeration and ventilation is also possible. In another embodiment which is not shown here, an inlet/outlet valve combination, for example, comprising two 2/2-way solenoid valves may be provided, wherein the inlet valve which is connected to the supply input 83 is closed in the non-energized state and opened in the energized state and the outlet valve is opened in the non-energized state and closed in the energized state. According to another embodiment as a solenoid valve device 82, a 3/2-way solenoid valve can also be used as an aeration and ventilation valve having an aeration position and a ventilation position in combination with a 2/2-way solenoid valve as a retention valve which in its blocking position maintains the pressure at the control output.

Such a solenoid valve device 82 can in particular be used in each of the above-described embodiments in combination with a pressure sensor and a control pressure regulator which is implemented in the secondary electronic brake control device 41 in order to control the pneumatic pressure p_{St} applied at the control output 84.

Furthermore, the electro-pneumatic operating brake control 80 comprises a driver assistance system 93, such as, for example, an autopilot device or an emergency brake assistant, which can automatically produce braking requests which are then represented by an assistance braking request signal AS which in this instance is introduced, for example, both into the primary electronic brake control device 40 and into the secondary electronic brake control device 41, as shown in FIG. 2. Alternatively, the assistance braking request signal AS could also be introduced only into the secondary electronic brake control device 41. With the autopilot device, at least partially autonomous driving is possible.

The routines of the driver assistance system 93 could also be implemented in the primary electronic brake control device 40 and/or in the secondary electronic brake control device 41.

Furthermore, the primary electronic brake control device 40 is supplied with electrical energy from a primary supply source 52 which is independent of a secondary supply source 58 which supplies the secondary electronic brake control device 41 with electrical energy.

Last and not least, the wheel speed signals of the first, second, third and fourth wheel speed sensors are introduced via signal connections which are not shown here both into the primary electronic brake control device 40 and into the secondary electronic brake control device 41. Since preferably both in the primary electronic brake control device 40 and in the secondary electronic brake control device 41 routines of a vehicle dynamic control (ESP) with subordinate anti-lock braking function (ABS) and traction control function (TCS) and roll-over protection function (ROP) are implemented, both brake control devices 40 and 41 can in each case control and regulate these functions.

A normal operation, a first redundancy level and a second redundancy level of the electro-pneumatic operating brake device will now be described below.

### NORMAL OPERATION

### Driver Braking

When the driver activates the operating brake actuation member 94 of the operating brake valve device 18, which corresponds to a driver braking request, in the intact primary electrical operating brake circuit the extent of the actuation of the two redundant brake value transmitters 86 which are preferably arranged axially one behind the other and which preferably act in a contactless manner is measured. The electrical actuation signal BS detected by the brake value transmitter 86 is produced in the electrical channel of the operating brake valve device 18, made data-bus-compatible and introduced via the primary control connection PV1 into the primary electronic brake control device 40. Since in the primary electronic brake control device 40 higher functions, such as, for example, an axle-load-dependent brake force distribution are implemented, at that location on the basis of the electrical actuation signal BS a first braking request signal S1 is produced separately in each case for the front axle VA and the rear axle HA and introduced into the relevant channel of the pressure regulation module 20 and into the trailer control module 24. At that location, in each case by the integrated solenoid valves and the relay valves based on the respective braking request signal S1, the brake pressure p_{VA} for the front axle VA and the brake pressure p_{HA} for the rear axle HA are then produced and introduced via the in this instance, for example, open pressure control valves 28 into the wheel brake actuators 4 in order to implement the required operating braking. In a similar manner, the supporting control module 24, which is also in the form of a pressure regulation module, converts the first braking request signal S1 into a trailer brake pressure p_{Anhänger} which is then introduced via a coupling head “trailer” which is not illustrated in this instance into a potentially coupled trailer.

For example, with the brake pressure p_{VA} for the front axle VA as a pneumatic control pressure, in the subordinate pneumatic brake circuit the trailer control module 24 is pneumatically controlled, but wherein this pneumatic control pressure is held back by the back-up valve which is integrated, supplied with energy and consequently closed and consequently not converted.

If an excessive brake slip occurs during the braking requested by the driver, the primary electronic brake control device 40 in which ABS routines are preferably implemented controls the pressure control valves 28 (FIG. 2) which are connected to the primary control connection SV1 and to the secondary control connection SV2 in order to regulate the brake pressure on an individual wheel basis until the brake slip becomes permitted.

Of course, the same also applies to an individual wheel control/regulation of the brake pressures in the context of a vehicle dynamic control ESP.

In parallel with this, with the driver braking request in the subordinate pneumatic operating brake circuit or in the two pneumatic channels of the operating brake valve device 18, the tappet piston 91 is displaced downward, wherein the tappet piston 91 is urged against the base of the cup-like sleeve 103 and the control piston 85 is also displaced downward until the outlet seat seals with respect to the valve member and consequently the connection between the control outputs 16, 17 for the pneumatic operating brake circuits and the ventilation connection 99 closes so that no further ventilation of the associated wheel brake actuators 4 can be carried out.

With continued activation of the operating brake actuation member 94 in response to the driver braking request, the valve member is then urged downward with the outlet seat abutting it being lifted off the inlet seat. Compressed air under store pressure is thereby introduced from the storage chamber 89 into the working chamber 98 and from there into the control outputs 16, 17 for the pneumatic operating brake circuits or into the associated wheel brake actuators 4 in order to ventilate them and consequently to apply them. This is purely a driver braking operation in which, as a result of the actuation force applied to the operating brake actuation member 94 by the driver in accordance with the driver braking request, via the tappet piston pressure spring 102 a first actuation force F1 is applied to the control piston 85 which ultimately places it in its ventilation position.

With such a braking action which is initiated purely by a driver braking request, the solenoid valve device 82 is controlled by means of the secondary electronic brake control device 41 into the ventilation position in which the control chamber 90 is connected to the atmosphere in order to prevent pressure effects which can arise as a result of the expansion of the control chamber 90. The instruction for this is received by the secondary electronic brake control device 41, for example, via the data connection 101 from the primary electronic brake control device 41.

Since, however, the primary electrical operating brake circuit is intact, the first and second brake control pressures p1 and p2 which are present at the control outputs 16, 17 and which are introduced via the control lines 22, 23 into the pneumatic control inputs 95, 96 of the pressure regulation module 20 are retained in the pressure regulation module 20 at the back-up valves which are then supplied with energy and consequently closed and not transmitted to the integrated relay valves.

Consequently, with an intact primary electrical operating brake circuit, the subordinate pneumatic operating brake circuit is ineffective.

### Automatic/Autonomous Braking

The case will now be considered below in which the driver does not apply a braking request and therefore does not activate the operating brake actuation member 94, but instead in each case the driver assistance system 93 introduces an assistance braking request signal AS both into the primary electronic brake control device 40 and into the secondary electronic brake control device 41, as indicated in FIG. 2.

In this instance, the primary electronic brake control device 40 on the basis of the assistance braking request signal AS can produce a first electrical braking request signal S1 which is then converted in the electrical brake operating circuit as described above by the pressure regulation module 20 and the trailer control module 24 into corresponding brake pressures p_{VA}, p_{HA} and p_{Anhänger}. Consequently, the assistance braking request signal AS is then converted by the intact electrical operating brake circuit or the intact pressure regulation module 20.

In parallel therewith or at the same time, the secondary electronic brake control device 41 produces on the basis of the assistance braking request signal AS the second electrical braking request signal S2 which is introduced via the secondary control connection SV2 into the solenoid valve device 82 which is subsequently moved into the ventilation position and thereby produces the pneumatic control pressure p_{St} at which the control chamber 90 is acted on. The control pressure p_{St} which is then applied in the control chamber 90 reacts to the tappet piston 91 which limits it and consequently to the operating brake actuation member 94, which the driver can feel on his/her foot when he/she touches the operating brake actuation member 94 (pedal reaction). Consequently, the driver can feel an introduction of an automatic braking on the foot.

Depending on the modulation of the pneumatic control pressure p_{St} which is introduced into the control chamber 90, it is then possible to adjust a defined second actuation force

F2 on the control piston 85. The second actuation force F2 which preferably acts with respect to the first actuation force F1 in a parallel manner and in the same direction on the control piston 85 ensures as described above for the first actuation force F1 a production of the first and second pneumatic brake control pressure p1, p2 which are introduced at the control outputs 16, 17 and via the control lines 22, 23 into the pressure regulation module 20. At that location, however, the first and second pneumatic brake control pressure p1, p2 are held back by the back-up valves which are supplied with energy by the primary electronic brake control device 40 and which are consequently kept closed and are therefore (initially) inactive. However, the first and second pneumatic brake control pressure p1, p2 can immediately become effective in the pressure regulation module 20 at the integrated relay valves when the back-up valves as a result of a defect in the electrical operating brake circuit become deenergized and thereby open.

### Combination of Driver Braking and Autonomous/Automatic Braking

Furthermore, a situation is also conceivable in which both in response to a driver braking request and to an automatically generated braking request a braking operation is intended to be carried out, for example, when the driver as a result of an emergency braking situation brakes, but the braking request of the driver assistance system, for example, in the form of an emergency brake assistance or an autopilot device, is greater than the braking request of the driver.

Then, in the electrical operating brake circuit which is controlled by the primary electronic brake control device 40, primarily on the basis of the assistance braking request signal AS the brake pressures p_{VA} or p_{HA} are formed. In other words, in the primary electrical operating brake circuit the braking request of the driver is overridden by the braking request of the driver assistance system.

In parallel, on the one hand, the first actuation force F1 from the driver braking request and the second actuation force F2 from the automatically generated braking request act on the control piston 85 of the operating brake valve device 18 in the same direction and in parallel, wherein the actuation forces F1, F2 are added together at the control piston 85 and then at the control outputs 16, 17 the first pneumatic brake control pressure p1 and the second pneumatic brake control pressure p2 are controlled via the control lines 22, 23 into the pneumatic control inputs 95, 96 of the pressure regulation module 20, but are held back at that location by the back-up valves which are supplied with energy by the primary electronic brake control device 40.

### FIRST REDUNDANCY LEVEL

If a defect or error now occurs in the primary electrical operating brake circuit, whether it be as a result of the fact that the primary supply source 52, the primary electronic brake control device 40 and/or the electrical/electronic portion of the pressure regulation module 20 has a defect or has failed, the two back-up valves which are integrated in the pressure regulation module 20 are deenergized and thereby switch into their open position, whereby in the case of a braking request by the driver assistance system 93, that is to say, after the second electrical braking request signal S2 has been produced, the first and second brake control pressures p1, p2 which are already present at that location can control the relevant integrated relay valve, whereby the brake pressure p_{VA} for the front axle VA and the brake pressure p_{HA} for the rear axle HA can be produced. Since in this instance, for example, the brake pressure p_{VA} for the front axle is used as a pneumatic control pressure for the trailer control module 24, the trailer brake pressure p_{Anhänger} can also be produced so that a trailer which may be coupled can also be braked.

In the first redundancy level, therefore, it can be assumed that the secondary electronic brake control device 40 is intact since otherwise no second electrical braking request signal S2 can be produced and in accordance with this the first and second pneumatic brake control pressures p1 and p2 can be formed.

For wheel individual adaptation of the brake pressures p_{VA} and p_{HA}, for example, in the context of an anti-lock braking ABS, a traction control TCS and/or a vehicle dynamic control ESP, the intact secondary electronic brake control 41 can control the pressure control valves 28 via the secondary control connection SV2 individually (“hold pressure”, “decrease pressure”, “increase pressure”).

In the first redundancy level, in the event of a failed electrical operating brake circuit, there is therefore, as a result of the first and second pneumatic brake control pressures p1 and p2 in the then effective first and second pneumatic brake circuits, an electrical redundancy since the first and second pneumatic brake control pressures p1 and p2 are then produced electrically and automatically by means of the secondary electronic brake control device 40.

Furthermore, in the event of a failed electrical operating brake circuit as a result of the first and second pneumatic brake control pressures p1 and p2 in the then also effective first and second pneumatic brake circuits, an automatic braking request is implemented, wherein the first and second brake control pressures p1 and p2 in the event of a failed electrical operating brake circuit can then become immediately effective since they have already been produced in response to the assistance braking request signal AS and are then also already present at the back-up valves at the pressure regulation module 20.

### SECOND REDUNDANCY LEVEL

If starting from the state of the electro-pneumatic operating brake device 18 in the first redundancy level, that is to say, when the primary electronic brake control device 40 has failed, a defect or error in the control of the pneumatic operating brake circuit occurs as a result of the secondary electronic brake control device 41 and the solenoid valve device 82, the first and second pneumatic brake control pressure p1 and p2 can no longer be formed electrically so that no further autonomous or automatic braking operation by the driver assistance system 93 is also possible.

The pneumatic operating brake circuit can then only be controlled by braking requests of the driver and the first and second pneumatic brake control pressures p1 and p2 which are then produced mechanically. Since the back-up valves in the pressure regulation module 20 are then deenergized and consequently switched into their passage position, the first and second pneumatic brake control pressure p1 and p2 bring about a generation of the brake pressure p_{VA} for the front axle and the brake pressure p_{HA} for the rear axle HA in the pressure regulation module 20. Since the brake pressure p_{VA} for the front axle VA is preferably used as a pneumatic control pressure for the trailer control module 24, the trailer brake pressure p_{Anhänger} can also be produced so that a trailer which may be coupled to the vehicle can also be braked.

As a result of the failure of all the electrical operating brake circuits, however, a pressure regulation and a control of the pressure control valves 28 is no longer possible so that the brake pressures p_{VA} und p_{HA} can no longer be controlled on an individual wheel basis.

As described above, therefore, the electro-pneumatic operating brake device 80 and in particular the secondary electronic brake control device 41 (as a result of a corresponding programming), the solenoid valve device 82 and the operating brake valve device 18 are configured in such a manner that the first and second pneumatic brake control pressures p1 and p2, for example, in response to each automatically produced assistance braking request signal AS, which represents an autonomous or automatic braking request, are produced and are then immediately and directly present at the electromagnetic back-up valve, which is (still) closed as a result of being supplied with energy, of the pressure regulation module 20.

Regardless of whether a driver braking operation and/or an automatic braking operation are now requested, therefore, the first pneumatic brake control pressure p1 and the second pneumatic brake control pressure p2 are always already present in the pressure regulation module 20 and can therefore immediately after the failure of the electrical operating brake circuit ensure a production of the brake pressures p_{VA}, p_{HA} and p_{Anhänger}. In order, however, to reduce wear on the solenoid valve device 82 and on the operating brake valve device 18, which as described above are actually activated with each autonomous or automatic braking request, and in order to also reduce the resultant acoustic loading, only the pneumatic control pressure p_{St} and/or the first and second pneumatic brake control pressures p1 and p2 are then preferably electrically produced when the value of the automatic or autonomous braking request represented by the assistance braking request signal AS is greater than the value of a limit braking request a_{grenz}. This limitation may, for example, be produced by a corresponding programming of the secondary electronic brake control device 41.

Preferably, therefore, the limit braking request a_{grenz} is a deceleration which is different from zero or represents such a deceleration, for example, −3 m/s². If, therefore, for example an automatic or autonomous braking request (deceleration) of −4 m/s² is requested, the first and second pneumatic brake control pressures p1 and p2 would be produced electrically, but not with an automatic or autonomous braking request (deceleration) or only −2 m/s².

Alternatively, however, the limit braking request a_{grenz} may also be equal to zero, wherein with each requested autonomous or automatic braking operation, in which the value of the braking request is greater than zero, the first and second pneumatic brake control pressures p1 and p2 are electrically produced.

The first and second pneumatic brake control pressures p1 and p2 can also be produced in accordance with at least one of the following variables and introduced into the pneumatic control inputs 95, 96 of the pressure regulation module 20:
a) a mass ratio between the pulling vehicle and the trailer,
b) the axle loads of the rear axle HA and the front axle VA or the axle load ratio between the rear axle HA and the front axle VA,
c) the number of pneumatic channels of the operating brake valve device.

### SENSOR REDUNDANCY

During the regulation which in this instance is preferably fully integrated in the primary control device 40 and the secondary control device 41, in this instance in particular ABS control, problems may occur if, for example, the signal connection between a wheel speed sensor 5A-5D and the primary control device 40 and/or the secondary control device 41 is erroneous or disrupted, for example, when a plug which is connected to the signal line has fallen from the relevant wheel speed sensor 5A-5D and has a contact error or the signal line itself has an interruption.

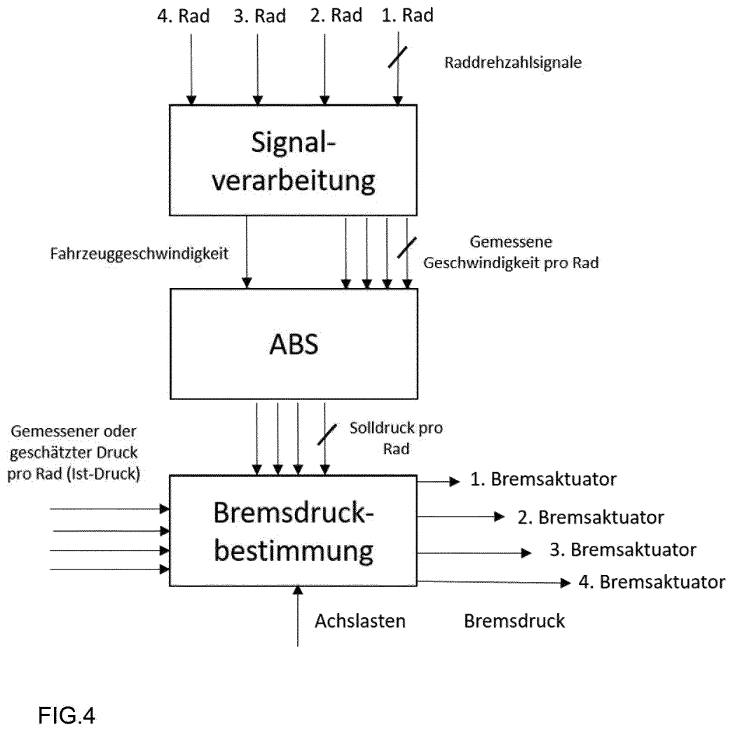

FIG. 4 illustrates functional units “signal processing”, “ABS” and “brake pressure determination” which during a braking operation, which is in this instance assumed in the context of the anti-slip braking (ABS), determine the individual brake pressures for the wheel brake actuators 4. These functional units are produced in a program code and can either be arranged in the operating brake device 80 of FIG. 1 and FIG. 2 so as to be distributed, for example, on the primary control device 40, the secondary control device 41 and/or the electronic control device of the pressure regulation module 20, or also fully integrated in only one of these control devices and in at least two of these control devices.

FIG. 4 then illustrates operation of the anti-lock braking system (ABS) when a wheel speed signal has failed, in particular as a result of one of the above-described problems.

Specifically, in the example illustrated in FIG. 4, it is assumed that the wheel speed signal of the first wheel speed sensor 5A associated with the first wheel 1A (for example, left front wheel) has failed. Whilst all other wheel speed sensors 5B, 5c and 5D can therefore introduce the respective wheel speed signal into a signal processing which is, for example, integrated in each case in the two control devices 40, 41, this is not the case with the first wheel speed signal of the first wheel speed sensor 5A, which is depicted in FIG. 4 by the cross bar.

The functional unit “signal processing” can then calculate from the wheel speed signals the wheel speeds of the second, third and fourth wheel 1B, 1C and 1D and the vehicle speed, but not the wheel speed of the first wheel 1A, which is also indicated in FIG. 4 by a cross bar. The functional unit “ABS” then calculates from the vehicle speed and the wheel speeds of the three wheels 1A, 2A and 3A in each case the individual desired brake pressures for the associated brake actuators 4 of these wheels 1A-1C, which with respect to the embodiment of the operating brake device 80 of FIG. 1 and FIG. 2 are then introduced as desired brake pressure signals into the pressure regulation module 20 in order to adjust these desired brake pressures, for example, in the context of a brake pressure regulation in each case in the brake actuators 4. Since in the pressure regulation module 20 the actual brake pressures can be measured by means of integrated pressure sensors, a feedback of the actual brake pressures can be carried out in the functional unit “brake pressure determination” in order to produce a brake pressure control. Consequently, the actual brake pressures which are present in the wheel brake actuators 4 of the first, second and third wheel 1A, 1B, 1C during the ABS control and also the respective desired brake pressures are known.

Furthermore, the functional unit “brake pressure determination” receives information items relating to the axle load of the first axle 2A (in this instance: front axle VA) and the axle load of the second axle 2B (in this instance: rear axle HA), for example, from axle load sensors which are installed in each case at that location. Alternatively, the values for the axle loads or for the axle load ratio can also be estimated from other detected values without axle load sensors being provided.

Furthermore, the functional unit “brake pressure determination” can establish from the wheel speed signals of the wheel speed sensor 5C of the third wheel 1C and the wheel speed sensor 5D of the fourth wheel 1D on the second axle 2A in the context of a μ-split identification whether during the braking operation a μ-split situation is present, that is to say, whether the carriageway friction coefficient μL between the wheels 1A, 1C at the left vehicle side and the carriageway differs from the carriageway friction coefficient μR between the wheels 1B, 1D at the right vehicle side and the carriageway or not. This is because, in the case of a significant difference of the carriageway friction coefficients μR and μL, in the individual wheel brake pressure determination in the context of the ABS control different brake pressures for the wheels of the left and right vehicle side are intended to be adjusted or regulated so that the vehicle does not rotate about its vertical axis during the braking operation.

Preferably, in the functional unit “brake pressure determination”, the first brake pressure which initially cannot be determined as a result of the missing wheel speed information of the first wheel speed sensor for the brake actuator 4 of the first wheel 1A is determined in that, for example, the second brake pressure for the brake actuator 4 of the second wheel 1B, which is arranged on the same axle 2A as the first wheel 1A is used as a basis for the determination.

This may, for example, be carried out, for example, by the second actual brake pressure which has been measured internally in the pressure regulation module 20 or the second desired brake pressure which has been calculated by the functional unit “ABS” being used for the brake actuator of the second wheel 1B or the respective time path. Optionally, the determination of the first brake pressure p1 for the brake actuator 4 of the first wheel 1A cannot be carried out only in accordance with the second actual/desired brake pressure p2, but also in accordance with the measured or estimated axle loads of the first axle 2A and the second axle 2B and/or the carriageway friction coefficients μR and μL at the right and left vehicle side.

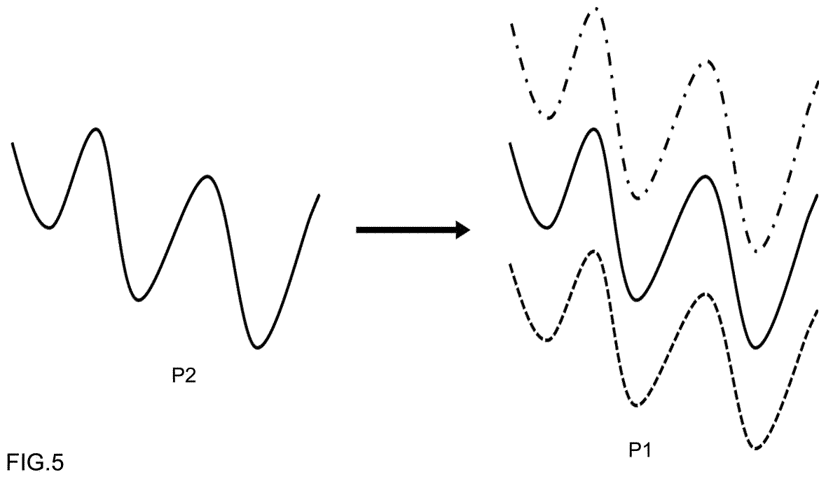

FIG. 5 illustrates on the left the time path of the second brake pressure p2 as formed by the functional unit “ABS” for the wheel brake actuator 4 of the second wheel 1B during the braking operation and illustrates on the right the first brake pressure p1 for the wheel brake actuator 4 of the first wheel 1A as determined in accordance with the method described above. The time paths illustrated herein characterize the ABS control cycles, which are produced from the typical change of brake pressure reductions and brake pressure increases. Preferably, the determination of the first brake pressure p1 for the wheel brake actuator 4 of the first wheel 1A is in this instance carried out not only in accordance with the second brake pressure p2, but also in accordance with the carriageway friction coefficients μR and μL at the right and left vehicle side which are estimated from the wheel speed signals of the wheel speed sensors 5C and 5D of the wheels 1C and 1D on the second axle 2B (in this instance: rear axle HA).

The mean time path which is illustrated with a solid line for the first brake pressure is established when there is no significant difference between the carriageway friction coefficients μR and μL on the right and left vehicle side. In this this instance, the time path of the second brake pressure p2 is substantially “copied” in order to replicate the time path, which is unknown as a result of missing wheel speed information, of the first brake pressure p1.

If, with reference to the μ-split identification, it has been found that during the braking operation there is a μ-split situation and it has been recognized in this instance that the carriageway friction coefficient μR between the wheels 1B, 1D at the right vehicle side and the carriageway is significantly greater than the carriageway friction coefficient μL between the wheels 1A, 1C at the left vehicle side and the carriageway, a time path, which is illustrated in FIG. 5 on the right with a dot-dash line, of the first brake pressure p1 is determined and is on average greater than the time path of the second brake pressure p2. In other words, the “copied” time path of the second brake pressure p2 is then raised by an offset Δp in order to avoid a rotation of the vehicle about the vertical vehicle axis during the ABS-controlled braking operation.

Otherwise, if, with reference to the μ-split identification, it has been found that a μ-split-situation is present during the braking operation and it has been recognized that the carriageway friction coefficient μL between the wheels 1A, 1C at the left vehicle side and the carriageway is significantly greater than the carriageway friction coefficient μR between the wheels 1B, 1D at the right vehicle side and the carriageway, a time path, which is illustrated on the right in FIG. 5 with a dotted line, of the first brake pressure p1 is determined and on average is smaller than the time path of the second brake pressure p2. In other words, the “copied” time path of the second brake pressure p2 is then lowered by an offset Δp.

Since the brake pressure p2 represents a brake pressure which is regulated by the ABS control, as a result of the above-described method the first wheel 1A is then also braked with a “copied” controlled first brake pressure p1. The actually unknown time path of the first brake pressure is then substantially reproduced by the time path, which has been produced by means of the ABS control, of the second brake pressure p2. Optionally or where necessary, this reproduced time path of the first brake pressure p1 can be adapted in accordance with an identified μ-split situation and/or in accordance with the measured or estimated axle loads.

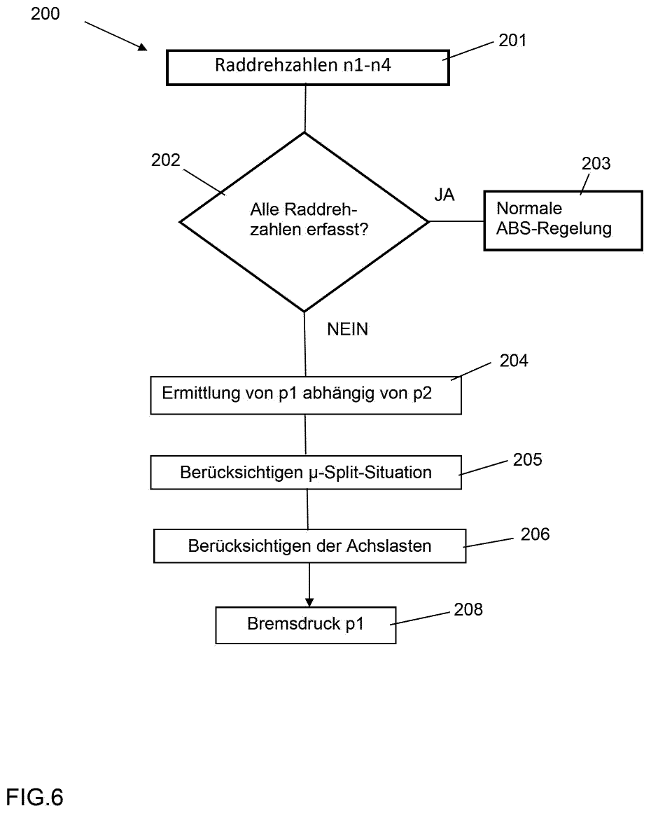

Below with reference to the flow chart 200 according to FIG. 6 it will be explained how the program code of the method reacts to the failure of the wheel speed signal of the first wheel speed sensor 5A.

In a step 201, the wheel speeds n1-n4 of the first, second, third and fourth wheel speed sensors 5A, 5B, 5C and 5D are input into the ABS control and in a step 202 there is a check as to whether at least one of the wheel speed sensors cannot be input since the corresponding wheel speed signal is absent or erroneous.

If this check in step 202 shows that all four wheel speeds n1-n4 can be detected without error (“YES”), in step 203 these wheel speeds are input and evaluated in order to carry out a normal ABS control. Otherwise (“NO”), if with respect to the above case, for example, the first wheel speed n1 of the first wheel speed sensor 5A cannot be detected, then in a step 204 the first brake pressure p1 is established in accordance with the second brake pressure p2 formed on the basis of the detected second wheel speed n2, as explained, for example, above in connection with FIG. 5.

In another now optional step 205, the reproduced first brake pressure p1 for the brake actuator 4 of the first wheel 1A is adapted to the (one) first axle 2A in accordance with the result of a μ-split identification, that is to say, depending on whether with reference, for example, to wheel speed signals detected on the (other) second axle 2B, a μ-split situation has been identified or not. A μ-split situation which has been identified under some circumstances is thereby incorporated into the determination of the first brake pressure p1.

In another step, also an optional step 206, the reproduced first brake pressure p1 for the brake actuator 4 of the first wheel 1A is adapted to the (one) first axle 2A in accordance with the detected or estimated axle loads.

Finally, in step 208, the first brake pressure p1 which is optionally adapted and reproduced in accordance with the second brake pressure p2 is, for example, converted as a desired pressure value by the pressure regulation module 20 of FIG. 1 and FIG. 2 and introduced into the brake actuator 4 of the first wheel 1A. As explained above, the steps 205 and 206 are optional in the method and can also be carried out in any order, in particular a reverse order.

According to another embodiment which is not described in detail here, on at least one axle of the vehicle, for example, on a second rear axle, no wheel speed sensors may be provided so that there are also no wheel speed signals from there. With such a configuration, the step 202 of the method is then omitted, since it is already known that there is no wheel speed information from specific wheels. However, for wheel brake actuators of such wheels, individual wheel brake pressures can also be produced when they are determined in accordance with at least one brake pressure of another axle, in particular using the step 204 and optionally using the steps 205 and 206.

In this instance, the first brake pressure p1R on the right, non-speed-sensed wheel of the second rear axle can be determined in accordance with the second brake pressure p2R of the right wheel of the first rear axle at the same side and in accordance with the axle load ratio between the first and second rear axle. In a similar manner, the first brake pressure p1L on the left, non-speed-sensed wheel of the second rear axle can be determined, for example, in accordance with the second brake pressure p2L of the left wheel of the first rear axle at the same side and in accordance with the axle load ratio between the first and second rear axle.

### LIST OF REFERENCE NUMERALS

1A First wheel
1B Second wheel
1C Third wheel
1D Fourth wheel
2A First axle
2B Second axle
3 Disk brake
4 Wheel brake actuators
5A First wheel speed sensor
5B Second wheel speed sensor
5C Third wheel speed sensor
5D Fourth wheel speed sensor
10 Compressed air store
13 Control line
14 Supply line
14a Supply line
14b Supply line
14c Supply line
15 Supply input (foot brake module)
16 Control output (foot brake module, interface for front axle and trailer)
17 Control output (foot brake module, interface for rear axle)
18 Operating brake valve device
19 Control input, foot brake module
20 Pressure regulation module
22 Control line (for front axle and trailer module 24)
23 Control line (for rear axle)
24 Trailer control module
26 Line
27 Line
28 Pressure control valve
29 Brake line
40 Primary electronic brake control device
41 Secondary electronic brake control device
50 Brake line (to the trailer)
52 Primary supply source
58 Secondary supply source
80 Electro-pneumatic operating brake device
82 Solenoid valve device
83 Supply line (solenoid valve device)
84 Control output (solenoid valve device)
85 Control piston
86 Brake value transmitter
87 Tappet piston rod
88 Dual seat valve
89 Storage chamber
90 Control chamber
91 Tappet piston
92 Tappet receiving member
93 Driver assistance system
94 Operating brake actuation member
95 Pneumatic control input
96 Pneumatic control input
97 Electrical control input
98 Working chamber
99 Ventilation connection
100 Ventilation
101 Data connection
102 Tappet piston pressure spring
103 Sleeve
200 Flow chart
201-208 Method steps
SV1 (electronic) primary control connection
SV2 (electronic) secondary control connection
HA Rear axle
VA Front axle
BS Electrical activation signal
AS Assistance braking request signal
F1 First force
F2 Second force
S1 First electrical braking request signal
S2 Second electrical braking request signal
p1 First pneumatic brake control pressure
p2 Second pneumatic brake control pressure
pSt Pneumatic control pressure
pVA Brake pressure of front axle
PHA Brake pressure of rear axle
pAnhänger Trailer brake pressure

1. A method for determining or estimating a first brake pressure for a first of a brake actuator, which is included by a pressure-medium-actuated brake device, of at least a first wheel on which during a braking operation and/or while implementing a control which processes wheel speed signals a build-up of brake pressure is required, and on which no first wheel speed sensor is provided, or a first wheel speed sensor is provided but does not provide any or any error-free first wheel speed signal, wherein the method comprises at least the following steps:
a) determining, measuring or estimating during the braking operation and/or while the control is carried out a second brake pressure for a second brake actuator, which is included by the brake device, of at least one second wheel with which there is associated a second wheel speed sensor which provides a wheel speed signal; and
b) determining or estimating the first brake pressure in accordance with the second brake pressure.

2. The method as in claim 1, characterized in that the control comprises
a) a travel dynamic control (TDC) with a subordinate anti-lock brake control function and/or traction control function and/or roll-over protection function; and/or
b) an anti-lock braking control (ABS); and/or
c) a traction control system (TCS).

3. The method as in claim 1, characterized in that a selection is made from the wheels of the vehicle in order to identify at least one second wheel which is suitable for the determination or estimation of the first brake pressure for the first brake actuator of the at least one first wheel.

4. The method as in claim 1, characterized in that a wheel which is arranged on the same axle as the first wheel is used as the second wheel.

5. The method as in claim 1, characterized in that a wheel which is arranged on a different axle with respect to an axle on which the at least one first wheel is arranged is used as the second wheel.

6. The method as in claim 5, characterized in that a wheel which with respect to the vehicle side of the at least one first wheel is arranged
a) at the same vehicle side, or
b) at the other vehicle side
is used as the second wheel.

7. The method as in claim 1, characterized in that a μ-split identification in order to identify a μ-split situation is carried out during the braking operation and/or when the control is carried out.

8. The method as in claim 7, characterized in that the determination or estimation of the first brake pressure is also carried out in accordance with an identified μ-split situation.

9. The method as in claim 4, characterized in that
a) a wheel which is arranged on the same axle as the at least one first wheel is used as the second wheel, and in that
b) the determination or estimation of the first brake pressure is also carried out in accordance with an identified μ-split situation.

10. The method as in claim 1, characterized in that a determination or estimation of axle loads of the axles and/or an axle load distribution of the axles is carried out.

11. The method as in claim 10, characterized in that the determination or estimation of the first brake pressure is also carried out in accordance with the determined or estimated axle loads or the determined or estimated axle load distribution.

12. The method as in claim 6, characterized in that a wheel which is arranged on a different axle with respect to an axle on which the at least one first wheel is arranged is used as the second wheel but is arranged at the same vehicle side as the at least one first wheel, and in that the determination or estimation of the first brake pressure is also carried out in accordance with the determined or estimated axle loads or the determined or estimated axle load distribution.

13. A computer program stored on a non-transitory computer readable medium, comprising having a program code for carrying out the method as in claim 1 when the computer program is carried out on a processor device.

14. A control device comprising:
a processor device; and
a non-transitory computer readable medium store which contains the computer program as in claim 13.

15. A pressure-medium-actuated brake device, which is provided with at least one control which receives and processes wheel speed signals from wheel speed sensors as input signals, of a vehicle, wherein a brake actuator is associated in each case with wheels of the vehicle and there is associated in each case with at least some wheels of the vehicle a wheel speed sensor which produces wheel speed signals which correspond to the wheel speed, and wherein the brake device is configured
a) to determine or estimate a first brake pressure for a first brake actuator, which is included by the brake device, of at least a first wheel, on which during a braking operation and/or while a control which processes wheel speed signals is carried out a brake pressure build-up is necessary and on which no first wheel speed sensor is provided or a first wheel speed sensor is provided but does not provide any or any error-free first speed signal;
b) to determine, measure or estimate a second brake pressure for a second brake actuator, which is included by the brake device, of at least one second wheel during the braking operation and/or while the control is carried out and with which wheel there is associated a second wheel speed sensor which provides a wheel speed signal; and
c) to determine or estimate the first brake pressure in accordance with the second brake pressure.

16. A brake device as claimed in claim 15, characterized in that the control comprises
a) a vehicle dynamic control (ESP) with subordinate anti-lock brake control function and/or traction control function and/or roll-over protection function; and/or
b) an anti-lock braking control (ABS); and/or
c) a traction control system (TCS).

17. The brake device as in claim 15, characterized in that the brake device is configured to make a selection from the wheels of the vehicle in order to identify a second wheel which is suitable for the determination or estimation of the first brake pressure.

18. The brake device as in claim 15, characterized in that the second wheel is a wheel which is arranged on the same axle as the first wheel.

19. The brake device as in one of claim 15, characterized in that the second wheel is a wheel which is arranged on a different axle with respect to an axle on which the at least one first wheel is arranged.

20. The brake device as claimed in claim 19, characterized in that the second wheel is a wheel which is arranged with respect to the vehicle side of the at least one first wheel
a) at the same vehicle side; or
b) at the other vehicle side.

21. The brake device as in claim 15, characterized in that the brake device is configured so that a μ-split identification is carried out in order to identify a μ-split situation during the braking operation and/or while the control is carried out.

22. The brake device as in claim 21, characterized in that the brake device is configured so that the determination or estimation of the first brake pressure is also carried out in accordance with an identified μ-split situation.

23. The brake device as in claim 18, characterized in that
a) the second wheel is a wheel which is arranged on the same axle as the at least one first wheel, and in that
b) the brake device is configured so that the determination or estimation of the first brake pressure is also carried out in accordance with an identified μ-split situation.

24. The brake device as in claim 15, characterized in that the brake device is configured so that a determination or estimation of axle loads of the axles and/or an axle load distribution of the axles is carried out.

25. The brake device as in claim 24, characterized in that the brake device is configured so that the determination or estimation of the first brake pressure is also carried out in accordance with the determined or estimated axle loads or the determined or estimated axle load distribution.

26. The brake device as in claim 19, characterized in that
a) the second wheel is a wheel which is arranged on a different axle with respect to an axle on which the at least one first wheel is arranged, but is arranged at the same vehicle side as the at least one first wheel; and in that
b) the brake device is configured so that the determination or estimation of the first brake pressure is also carried out in accordance with the determined or estimated axle loads or the determined or estimated axle load distribution.

27. The brake device as in claim 15, characterized in that the brake device is an electro-pneumatic brake device having brake pressure regulation.

28. The brake device as in claim 15, characterized in that the control is implemented in at least one control device or a control device system of the brake device.

29. The brake device as in claim 28, characterized in that a primary control device and a secondary control device are provided, wherein the control is implemented in the primary control device and/or in the secondary control device.

30. The brake device as in claim 29, characterized in that at least some of the wheel speed sensors are connected to the primary control device and/or to the secondary control device in order to transmit wheel speed signals.
